(19) United States
(12) Patent Application Publication
(10) Pub. No.: US 2019/0055462 A1
(43) Pub. Date: Feb. 21, 2019

(54) Y-GRADE NGL FRACTURING FLUIDS

(71) Applicants: John A. BABCOCK, Houston, TX (US); Linde Aktiengesellschaft, Munich (DE)

(72) Inventors: John A. BABCOCK, Houston, TX (US); Charles P. SIESS, III, Conroe, TX (US)

(21) Appl. No.: 15/680,622

(22) Filed: Aug. 18, 2017

(51) Int. Cl. C09K 8/68; C09K 8/80; C09K 8/70; C09K 8/36; C09K 8/60

(52) U.S. Cl. CPC C09K 8/68; C09K 8/805; C09K 8/604; C09K 8/36; C09K 8/703

(57) ABSTRACT

Fracturing fluids in the form of a hydrocarbon foam, an emulsion based foam, an emulsion, and a gelled fracturing fluid, each comprising Y-Grade NGL, which is an unfractionated hydrocarbon mixture that comprises ethane, propane, butane, isobutane, and pentane plus, wherein the unfractionated hydrocarbon mixture is a byproduct of a condensed and de-methanized hydrocarbon stream.

### BACKGROUND

### Field of the Disclosure

Embodiments of this disclosure generally relate to fracturing fluids.

### Description of the Related Art

Fracturing fluids are used to stimulate and improve fluid conductivity between a wellbore and a formation of interest to increase fluid production. There is a need, however, for fracturing fluids that are non-damaging to hydrocarbon bearing formations, have minimal water content and chemical additives, are naturally occurring and locally available, have fast clean-up, are cost effective, and are recoverable with minimal proppant flow back.

### SUMMARY

In one embodiment, a fracturing fluid comprises a proppant; an unfractionated hydrocarbon mixture comprising ethane, propane, butane, isobutane, and pentane plus, wherein the unfractionated hydrocarbon mixture is a byproduct of a condensed and de-methanized hydrocarbon stream, wherein the unfractionated hydrocarbon mixture is condensed out of the hydrocarbon stream at a temperature at or below 0 degrees Fahrenheit, wherein the unfractionated hydrocarbon mixture comprises ethane, propane, and butane in an amount of at least 75% by volume, and wherein the unfractionated hydrocarbon mixture comprises pentane plus in an amount less than 30% by volume; and a chemical agent.

### BRIEF DESCRIPTION OF THE DRAWINGS

So that the manner in which the above recited features can be understood in detail, a more particular description of the embodiments briefly summarized above may be had by reference to the embodiments below, some of which are illustrated in the appended drawings. It is to be noted, however, that the appended drawings illustrate only typical embodiments and are therefore not to be considered limiting of its scope, for the embodiments may admit to other equally effective embodiments.

FIG. 1 is a schematic view of a foamed Y-Grade NGL fracturing system with a proppant and high pressure pumping system according to one embodiment.

FIG. 2 is a schematic view of a gelled Y-Grade NGL fracturing system with a proppant and high pressure pumping system according to one embodiment.

FIG. 3 is a schematic view of an emulsion Y-Grade NGL fracturing system with a proppant and high pressure pumping system according to one embodiment.

FIG. 4 is a vertical section of a high pressure foaming unit for use with Y-Grade NGL and nitrogen or carbon dioxide systems according to one embodiment.

FIG. 5 is a nozzle assembly for use with Y-Grade NGL foam and nitrogen and/or carbon dioxide systems according to one embodiment.

FIG. 6 is a schematic view of a fracturing fluid system according to one embodiment.

FIG. 7 is a schematic view of a fracturing fluid system according to one embodiment.

FIG. 8 is a schematic view of a fracturing fluid system according to one embodiment.

FIG. 9 is a schematic view of a fracturing fluid system according to one embodiment.

FIG. 10 is a schematic view of a fracturing fluid system according to one embodiment.

FIG. 11 is a schematic view of a Y-Grade NGL system for obtaining Y-Grade NGL according to one embodiment.

### DETAILED DESCRIPTION

Y-Grade natural gas liquids (referred to herein as Y-Grade NGL) is an un-fractionated hydrocarbon mixture comprising ethane, propane, butane, isobutane, and pentane plus. Pentane plus comprises pentane, isopentane, and/or heavier weight hydrocarbons, for example hydrocarbon compounds containing at least one of C5 through C8+. Pentane plus may include natural gasoline for example.

Typically, Y-Grade NGL is a by-product of condensed and de-methanized hydrocarbon streams that are produced from shale wells for example and transported to a centralized facility. Y-Grade NGL can be locally sourced from a splitter facility, a natural gas plant, and/or a refinery and transported by tanker truck or pipeline to a point of use. In its un-fractionated or natural state (under certain pressures and temperatures, for example within a range of 250-600 psig and at wellhead or ambient temperature), Y-Grade NGL has no dedicated market or known use. Y-Grade NGL must undergo processing known as fractionation to create discrete components before its true value is proven.

The Y-Grade NGL composition can be customized for handling as a liquid under various conditions. Since the ethane content of Y-Grade NGL affects the vapor pressure, the ethane content can be adjusted as necessary. According to one example, Y-Grade NGL may be processed to have a low ethane content, such as an ethane content within a range of 3-12 percent by volume, to allow the Y-Grade NGL to be transported as a liquid in low pressure storage vessels. According to another example, Y-Grade NGL may be processed to have a high ethane content, such as an ethane content within a range of 38-60 percent by volume, to allow the Y-Grade NGL to be transported as a liquid in high pressure pipelines.

Y-Grade NGL differs from liquefied petroleum gas (“LPG”). One difference is that LPG is a fractionated product comprised of primarily propane, or a mixture of fractionated products comprised of propane and butane. Another difference is that LPG is a fractioned hydrocarbon mixture, whereas Y-Grade NGL is an unfractionated hydrocarbon mixture. Another difference is that LPG is produced in a fractionation facility via a fractionation train, whereas Y-Grade NGL can be obtained from a splitter facility, a natural gas plant, and/or a refinery. A further difference is that LPG is a pure product with the exact same composition, whereas Y-Grade NGL can have a variable composition.

In its unfractionated state, Y-Grade NGL is not an NGL purity product and is not a mixture formed by combining one or more NGL purity products. An NGL purity product is defined as an NGL stream having at least 90% of one type of carbon molecule. The five recognized NGL purity products are ethane (C2), propane (C3), normal butane (NC4), isobutane (IC4) and natural gasoline (C5+). The unfractionated hydrocarbon mixture is sent to a fractionation facility, where it is cryogenically cooled and passed through a fractionation train that consists of a series of distillation towers, referred to as deethanizers, depropanizers, and debutanizers, to fractionate out NGL purity products from the unfractionated hydrocarbon mixture. Each distillation tower generates an NGL purity product. Liquefied petroleum gas is an NGL purity product comprising only propane, or a mixture of two or more NGL purity products, such as propane and butane. Liquefied petroleum gas is therefore a fractionated hydrocarbon or a fractionated hydrocarbon mixture.

In one embodiment, Y-Grade NGL comprises 30-80%, such as 40-60%, for example 43%, ethane; 15-45%, such as 20-35%, for example 27%, propane; 5-10%, for example 7%, normal butane; 5-40%, such as 10-25%, for example 10%, isobutane; and 5-25%, such as 10-20%, for example 13%, pentane plus. Methane is typically less than 1%, such as less than 0.5% by liquid volume.

In one embodiment, Y-Grade NGL comprises condensed, dehydrated, desulfurized, and de-methanized natural gas stream components that have a vapor pressure of not more than about 600 psig at 100 degrees Fahrenheit, with aromatics below about 1 weight percent, and olefins below about 1 percent by liquid volume. Materials and streams useful for the embodiments described herein typically include hydrocarbons with melting points below about 0 degrees Fahrenheit.

In one embodiment, Y-Grade NGL may be mixed with a chemical agent. The chemical agent may be mixed with a solubilizing fluid to liquefy any dry chemicals to aid in mixing with the Y-Grade NGL. The solubilizing fluid may comprise fractionated or refined hydrocarbons, such as C3, C4, C5, C6, C7, C8, C9, and mixtures thereof. The solubilizing fluid may comprise C3+ hydrocarbons, including propane, butane, pentane, naphtha, toluene, diesel, natural gasoline, and any combination thereof.

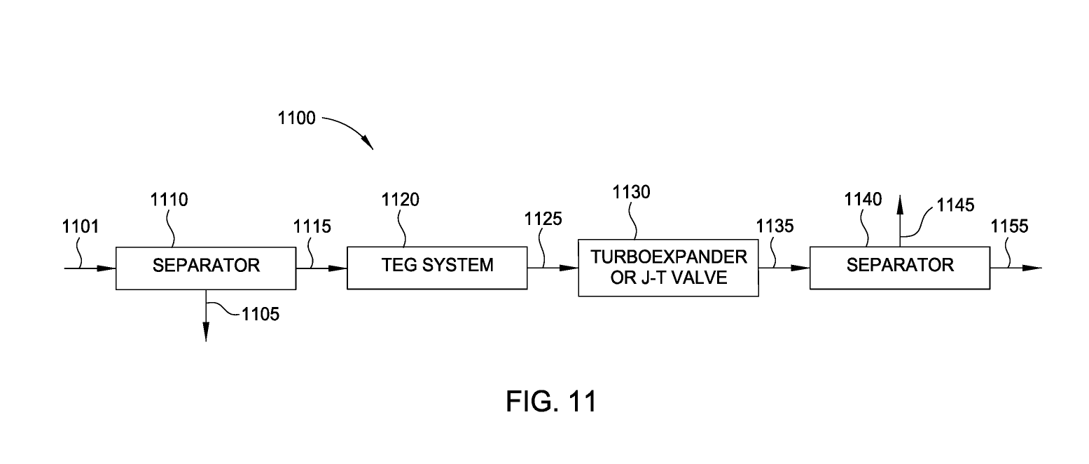

FIG. 11 is a schematic view of a Y-Grade NGL system 1100 for obtaining Y-Grade NGL, according to one embodiment, for use with embodiments described herein. The system 1100 may be part of a splitter facility, a natural gas plant, or a refinery. The system 1100 includes a first separator 1110, a triethylene glycol (“TEG”) system 1120, a turboexpander 1130 (or alternatively a Joule-Thompson valve), and a second separator 1140. A hydrocarbon stream 1101, such as a wet natural gas stream, flows into the first separator 1110 where it is separated into a liquid stream 1105 and a gas stream 1115. The liquid stream 1105 comprises liquid hydrocarbons and water. The gas stream 1115 flows into the TEG system 1120 where water vapor is removed to dehydrate the gas stream 1115. The TEG system 1120 dehydrates the gas stream 1115 that is discharged from the first separator 1110 to a water dew point up to −100 degrees Fahrenheit. The gas stream 1125 exiting the TEG system 1120 flows into the turboexpander 1130 (or alternatively the Joule-Thompson valve), which cools the gas stream 1125 to a temperature at or below 0 degrees Fahrenheit, for example to a temperature between 0 degrees Fahrenheit and −100 degrees Fahrenheit, for example about −30 degrees Fahrenheit.

The gas stream 1125 is cooled to a temperature at or below 0 degrees Fahrenheit to condense out Y-Grade NGL from the remaining gas stream, which is primarily methane. The cooled fluids 1135 flow into the second separator 1140 where the gas stream 1145, which is primarily methane, is separated out from the Y-Grade NGL 1155. As a result, the Y-Grade NGL 1155 is a byproduct of the condensed and de-methanized hydrocarbon stream 1101.

In one embodiment, the gas stream 1145 may also comprise ethane in an amount of about 1 percent to about 50 percent by volume. The amount of ethane separated out with the methane can be controlled by the pressure maintained in the second separator 1140. The pressure in the second separator 1140 may be about 600 psi or less. As the pressure is lowered in the second separator 1140, the ethane content of the gas stream 1145 is increased, and the ethane content of the Y-Grade NGL 1155 is decreased. The Y-Grade NGL 1155 may be used to form any of the fracturing fluids and/or with any of the systems described herein.

According to one example, Y-Grade NGL comprises about 43% ethane, about 27% propane, about 7% normal butane, about 10% isobutane, and about 13% pentane plus at a maximum vapor pressure of about 600 psig at 100 degrees Fahrenheit per American Society for Testing and Materials (ASTM) according to the standard testing procedure D-6378 with methane, aromatics, and olefin maximums of 0.5% L.V. % per GPA 2177, 1.0 wt % of total stream per GPA 2186 and 1.0 L.V. % per GPA 2186, respectively.

According to one example, Y-Grade NGL comprises about 28% ethane, about 42% propane, about 13% normal butane, about 7% isobutane, and about 10% pentane plus. According to one example, Y-Grade NGL comprises about 48% ethane, about 31% propane, about 9% normal butane, about 5% isobutane, and about 7% pentane plus. According to one example, Y-Grade NGL comprises about 37%-43% ethane, about 22%-23% propane, about 7% normal butane, about 9%-11% isobutane, and about 13%-16% pentane plus. According to one example, Y-Grade NGL comprises about 10%-20% of at least one hydrocarbon compound having five carbon elements (C₅) or more.

Y-Grade NGL may comprise one or more combinations, as a whole or in part, of the Y-Grade NGL examples and/or embodiments described herein.

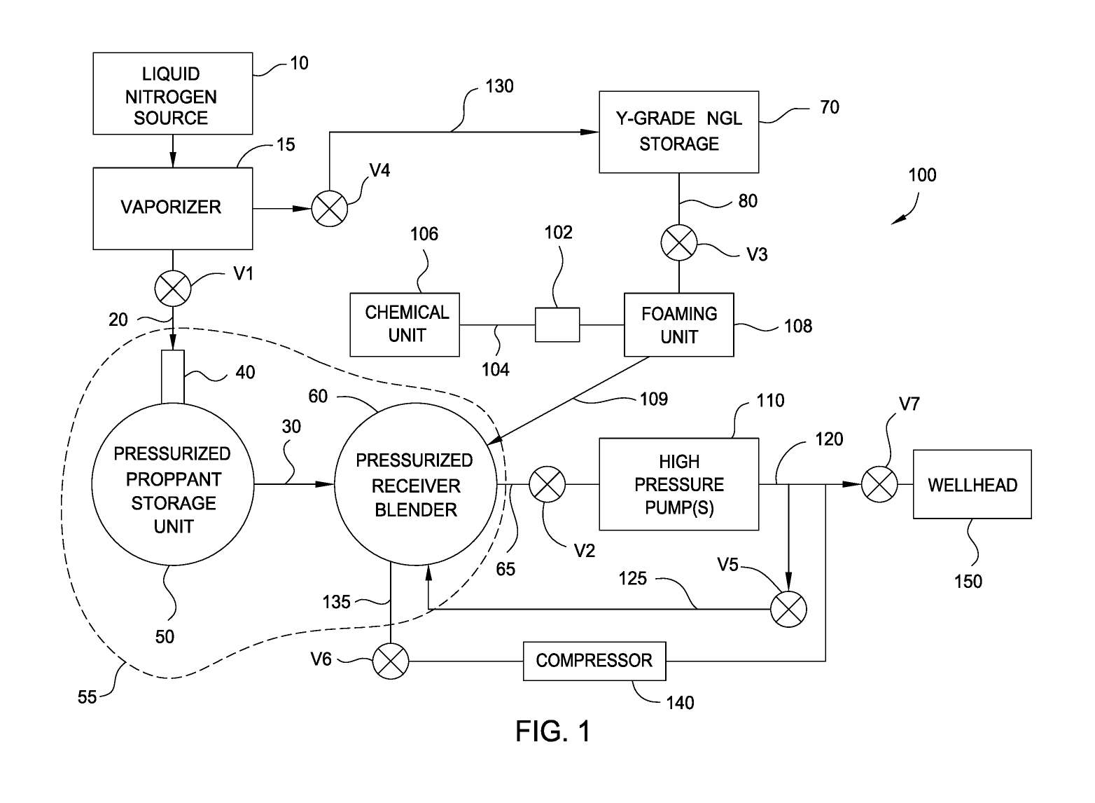

FIG. 1 shows a schematic view of a foamed Y-Grade NGL fracturing system 100 that can be used alone or in combination with any of the embodiments described herein. The fracturing system consists of a liquid nitrogen source 10 that is transferred to a vaporizer 15 to vaporize the liquid nitrogen into gaseous nitrogen. The liquid nitrogen source 10 may comprise air separation equipment configured to separate nitrogen from air to supply nitrogen to the liquid nitrogen source. The air separation equipment may be an ECOGAN™ modular air separation plant (developed by Linde AG Engineering) with a liquification unit.

The gaseous nitrogen is directed to an abrasion resistant venturi eductor 40 via a transfer line 20 and an automated control valve V1, and to a Y-Grade NGL storage unit 70 as a blanketing gas via a line 130 that is controlled by an automated valve V4. Proppant from a pressurized proppant storage unit 50 is fed into the abrasion resistant venturi eductor 40 and is transferred via a line 30 to a pressurized receiver blender 60. The pressurized proppant storage unit 50 and the pressurized receiver blender 60 may be in the form of a combined pressurized proppant blender unit 55.

Y-Grade NGL from the Y-Grade NGL storage unit 70 is transferred to a foaming unit 108 via a line 80 that is controlled by an automated valve V3. A chemical agent, such as a foaming agent, from a chemical unit 106 is transferred into the foaming unit 108 via a line 104 by a pump 102 to generate Y-Grade NGL foam. The Y-Grade NGL foam from the foaming unit 108 is transferred to the pressurized receiver blender 60 via a line 109 where it is mixed with the proppant.

The Y-Grade NGL foam-proppant mixture from the pressurized proppant blender unit 55 is transferred through a line 65 by the suction of one or more high pressure pumps 110. The line 65 is controlled by an automated valve V2. High pressure Y-Grade NGL proppant mixture is discharged from the high pressure pump 110 through a line 120 for injection as a fracturing fluid into a wellhead 150, and through a recycle line 125, which is controlled by an automated valve V5 back to the pressurized proppant blender unit 55 for mixing. Pressure within the pressurized proppant blender unit 55 is regulated via a line 135 by an automated valve V6 via the suction of a compressor 140, which is discharged to the wellhead 150 via the line 120 and an automated emergency shut-in valve V7.

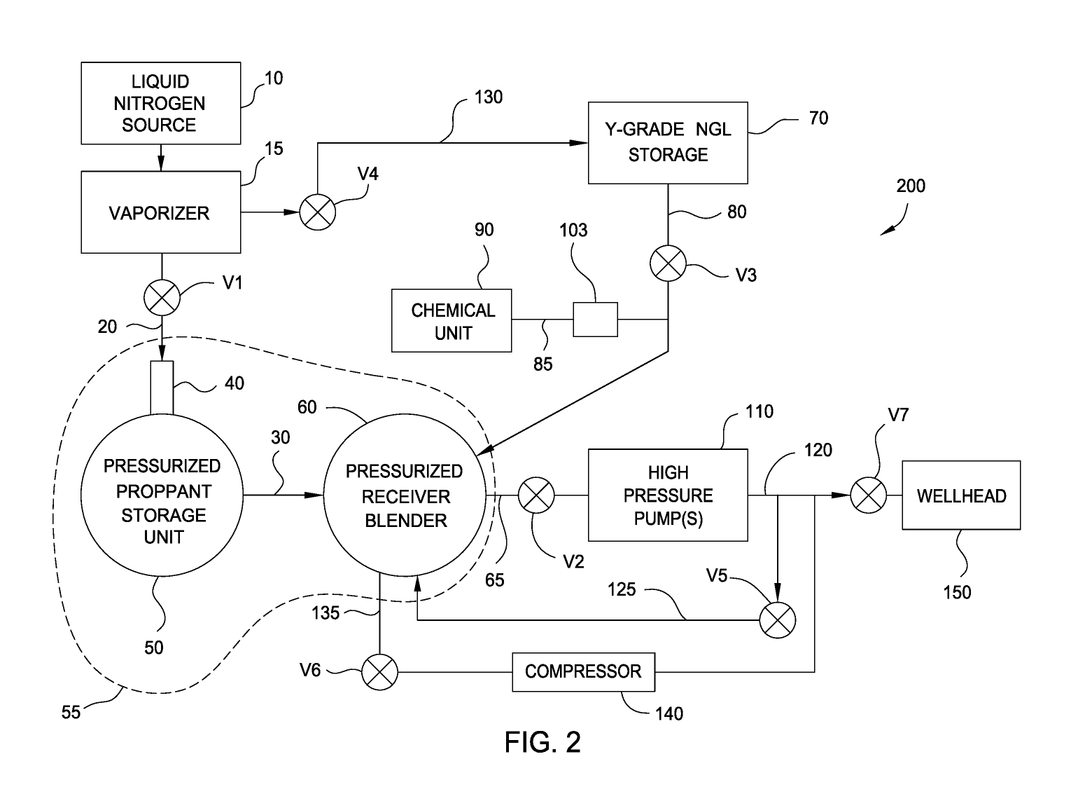

FIG. 2 shows a schematic view of a gelled Y-Grade NGL fracturing system 200 that can be used alone or in combination with any of the embodiments described herein. The fracturing system consists of a liquid nitrogen source 10 that is transferred to a vaporizer 15 to vaporize the liquid nitrogen into gaseous nitrogen. The gaseous nitrogen is transferred to an abrasion resistant venturi eductor 40 via a transfer line 20 and an automated control valve V1, and to a Y-Grade NGL storage unit 70 as a blanketing gas via a line 130 that is controlled by an automated valve V4. Proppant from a pressurized proppant storage unit 50 is fed into the abrasion resistant venturi eductor 40 and is transferred via a line 30 to a pressurized receiver blender 60. The pressurized proppant storage unit 50 and the pressurized receiver blender 60 may be in the form of a combined pressurized proppant blender unit 55.

Y-Grade NGL from the Y-Grade NGL storage unit 70 is transferred to the pressurized proppant blender unit 55 via a line 80 that is controlled by an automated valve V3. A chemical agent, such as a gelling agent, from a chemical unit 90 is transferred through a line 85 via a pump 103 into line 80 and the pressurized proppant blender unit 55 to form a gelled mixture. The gelled Y-Grade NGL proppant mixture from the pressurized proppant blender unit 55 is transferred to the suction of a high pressure pump(s) 110 through a line 65 that is controlled by an automated valve V2. High pressure Y-Grade NGL proppant mixture is discharged from the high pressure pump 110 through a line 120 for injection as a fracturing fluid into a wellhead 150, and through a recycle line 125, which is controlled by an automated valve V5 back to the pressurized proppant blender unit 55 for mixing. Pressure within the pressurized proppant blender unit 55 is regulated via a line 135 by an automated valve V6 via the suction of a compressor 140, which is discharged to the wellhead 150 via the line 120 and an automated emergency shut-in valve V7.

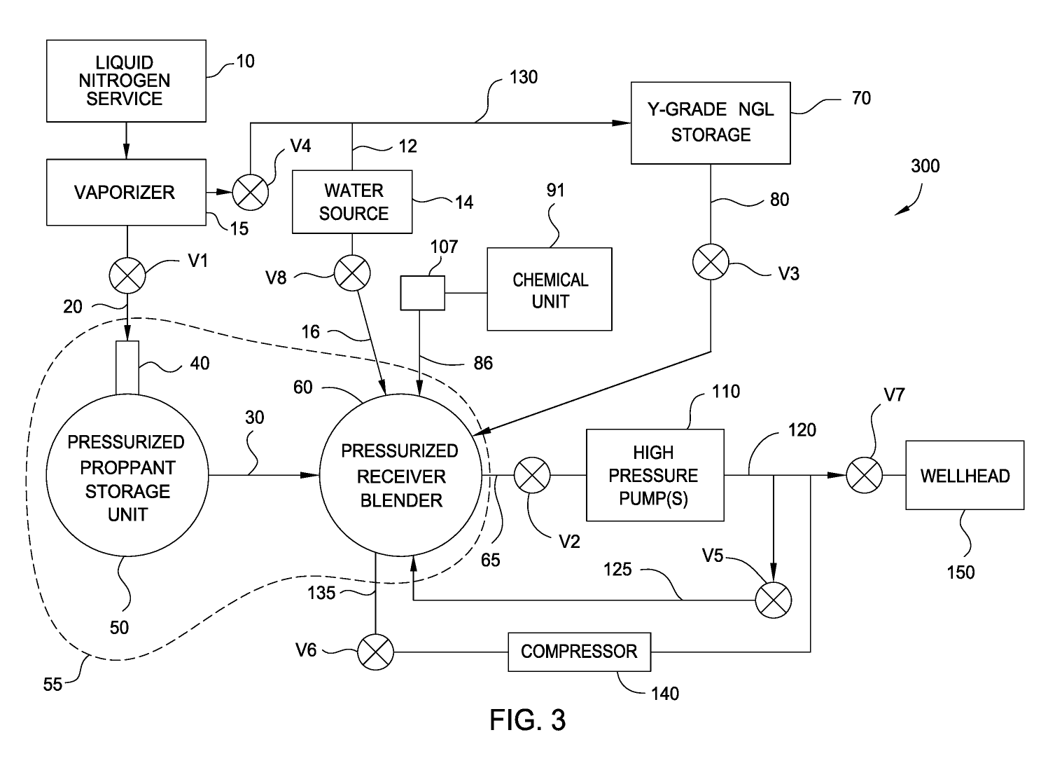

FIG. 3 shows a schematic view of an emulsion Y-Grade NGL fracturing system 300 that can be used alone or in combination with any of the embodiments described herein. The fracturing system consists of a liquid nitrogen source 10 that is transferred to a vaporizer 15 to vaporize the liquid nitrogen into gaseous nitrogen. The gaseous nitrogen is transferred to an abrasion resistant venturi eductor 40 via a transfer line 20 and an automated control valve V1; to a Y-Grade NGL storage unit 70 as a blanketing gas via a line 130 that is controlled by an automated valve V4; and to a water source 14 via a line 12 that is also controlled by the automated valve V4. Proppant from a pressurized silo 50 is fed into the abrasion resistant venturi eductor 40 and is transferred via a line 30 to a pressurized receiver blender 60. The pressurized proppant storage unit 50 and the pressurized receiver blender 60 may be in the form of a combined pressurized proppant blender unit 55. Y-Grade NGL from the Y-Grade NGL storage unit 70 is transferred to the pressurized proppant blender unit 55 via a line 80 that is controlled by an automated valve V3.

A chemical agent, such as an emulsifying agent, from a chemical unit 91 is transferred to the pressurized proppant blender unit 55 via a pump 107 via a line 86. Water from the water source 14 is transferred to the pressurized proppant blender unit 55 via a line 16 that is controlled by an automated valve V8. The Y-Grade NGL emulsion proppant mixture from the pressurized proppant blender unit 55 is transferred to the suction of a high pressure pump(s) 110 through a line 65 that is controlled by an automated valve V2. High pressure Y-Grade NGL proppant mixture is discharged from the high pressure pump 110 through a line 120 for injection as a fracturing fluid into a wellhead 150, and through a recycle line 125 that is controlled by an automated valve V5 to the pressurized proppant blender unit 55 for mixing. Pressure within the pressurized proppant blender unit 55 is regulated via a line 135 by an automated valve V6 via the suction of a compressor 140, which is discharged to the wellhead 150 via the line 120 and an automated emergency shut-in valve V7.

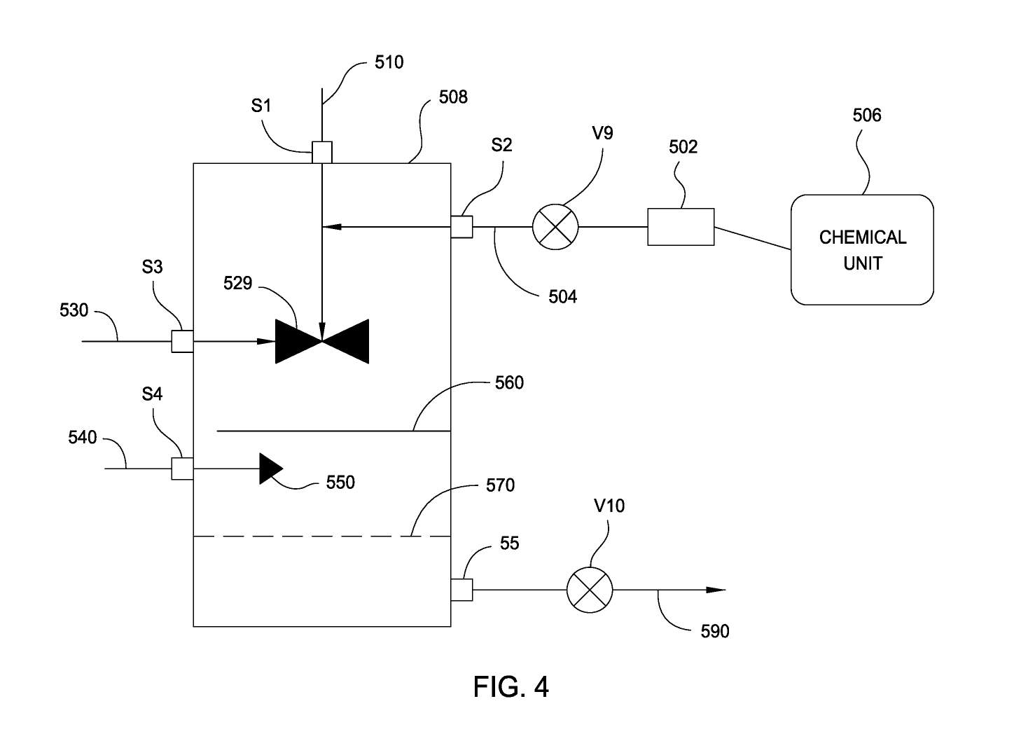

FIG. 4 shows a vertical section of a high pressure foaming unit 508, such as foaming unit 108 shown in FIG. 1, that can be used alone or in combination with any of the embodiments described herein. Y-Grade NGL from a Y-Grade NGL storage unit flowing into a line 510 penetrates the wall of the high pressure foaming unit 508 through a seal assembly S1. A chemical agent, such as a foaming agent, from a chemical unit 506, such as chemical unit 106 shown in FIG. 1, is injected into a line 504 penetrating the wall of the foaming unit 508 though a seal assembly S2 and delivered by a pump 502, such as pump 102 shown in FIG. 1, which is controlled by an automated valve V9.

The Y-Grade NGL and chemical agent mixture is delivered by the line 510 to a venturi eductor 529 where it is foamed with nitrogen that is delivered to the venturi eductor 529 by a line 530 penetrating the wall of the foaming unit 508 through a seal assembly S3. A foam spray exiting the venturi eductor 529 is diverted by a plate 560 to one or more high frequency ultrasonic sondes 550 that are powered by a line 540 penetrating the wall of the foaming unit 508 through a seal assembly S4, thereby creating micro-bubbles. The foam passes through a micro mesh screen 570 that removes larger bubbles and exits the foaming unit 508 through a line 590, which penetrates the wall of the foaming unit 508 through a seal assembly S5 and is controlled by an automated valve V10.

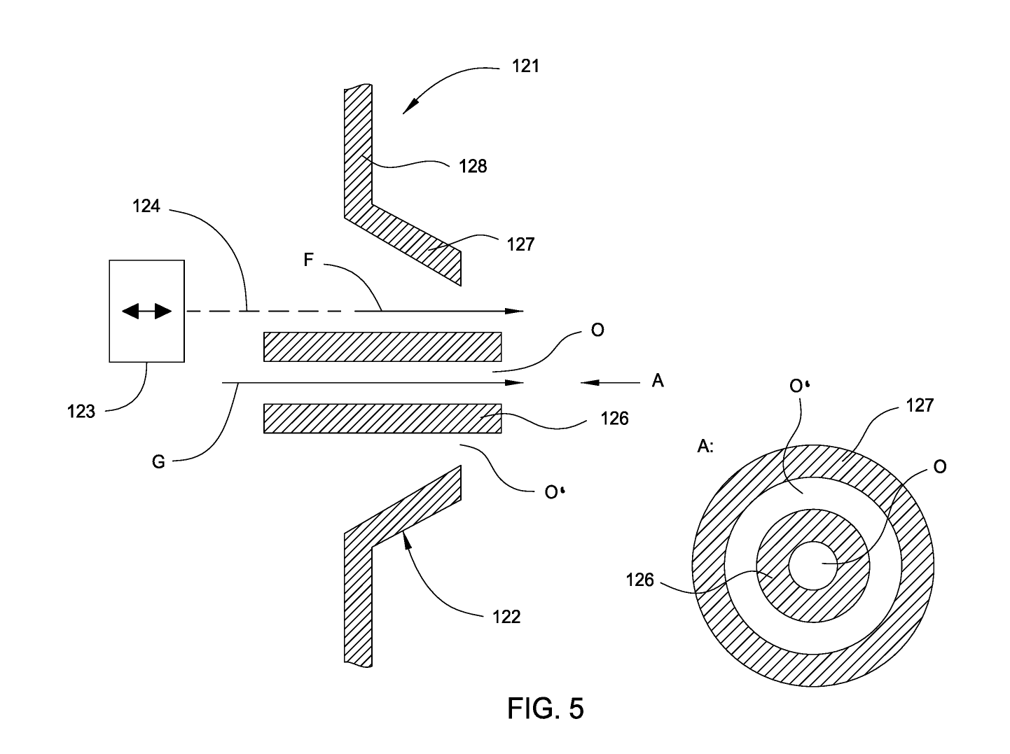

In one embodiment, the Y-Grade NGL and chemical agent mixture is pumped through a vibrating nozzle system, such as the venturi eductor 529 illustrated in FIG. 4 and/or a nozzle system 121 illustrated in FIG. 5, at ultrasonic frequency, wherein upon exiting, the mixture breaks up into uniform droplets. Vibration can be induced via an elastic membrane just before the mixture exits the nozzles. The amplitude and frequency of the nozzle oscillation can be held constant to attain a monodisperse droplet size distribution. The droplets can be directed at an angle into a tangential fluid flow to prevent rupturing of the droplets when exiting, such as through the line 590 shown in FIG. 4.

FIG. 5 shows a side view and a top view (when viewing in the direction of reference arrow “A”) of a nozzle system 121 according to one embodiment. The nozzle system 121 comprises a co-axial nozzle 122 having an inner nozzle 126 surrounded by an outer nozzle 127, and a nozzle plate 128 configured to support the inner and/or outer nozzles 126, 127. The inner nozzle 126 has an opening O and the outer nozzle has an opening O′, through which fluids such as liquids identified by reference arrow “F” and/or gases identified by reference arrow “G” flow. The co-axial nozzle 122 can be assembled so that gas flows through the inner nozzle 126 while liquid flows through the outer nozzle 127. A vibration generator 123, preferably a high frequency ultrasonic type, is configured to vibrate the co-axial nozzle 122 via a coupler 124. In one embodiment, the venturi eductor 529 illustrated in FIG. 4 may comprise the nozzle system 121 illustrated in FIG. 5.

In the embodiment illustrated in FIG. 5, solid proppant can mixed with the Y-Grade NGL foam after the foam generation stage to avoid plugging and/or abrasion of the inner and outer nozzles 126, 127. The Y-Grade NGL foam will be generated under pressure. The vibration generated by the vibration generator 123 is preferably generated in a specific direction, for example in the same or counter direction of the fluid flow through the inner and outer nozzles 126, 127 such that the fluid (liquids and/or gases) itself oscillates in the same orientation. The applied oscillating frequency is between about 16 kHz and about 200 MHz; between about 16 kHz and about 100 kHz; between about 16 kHz and about 50 kHz; and/or between about 16 kHz and about 30 kHz. The use of the nozzle system 121 results in a very narrow, monomodal bubble size distribution. Although only two nozzles are shown, the nozzle system 121 can comprise an array of inner and/or outer nozzles coupled to the nozzle plate 128. The narrow bubble size distribution leads to an optimized proppant carrying capacity.

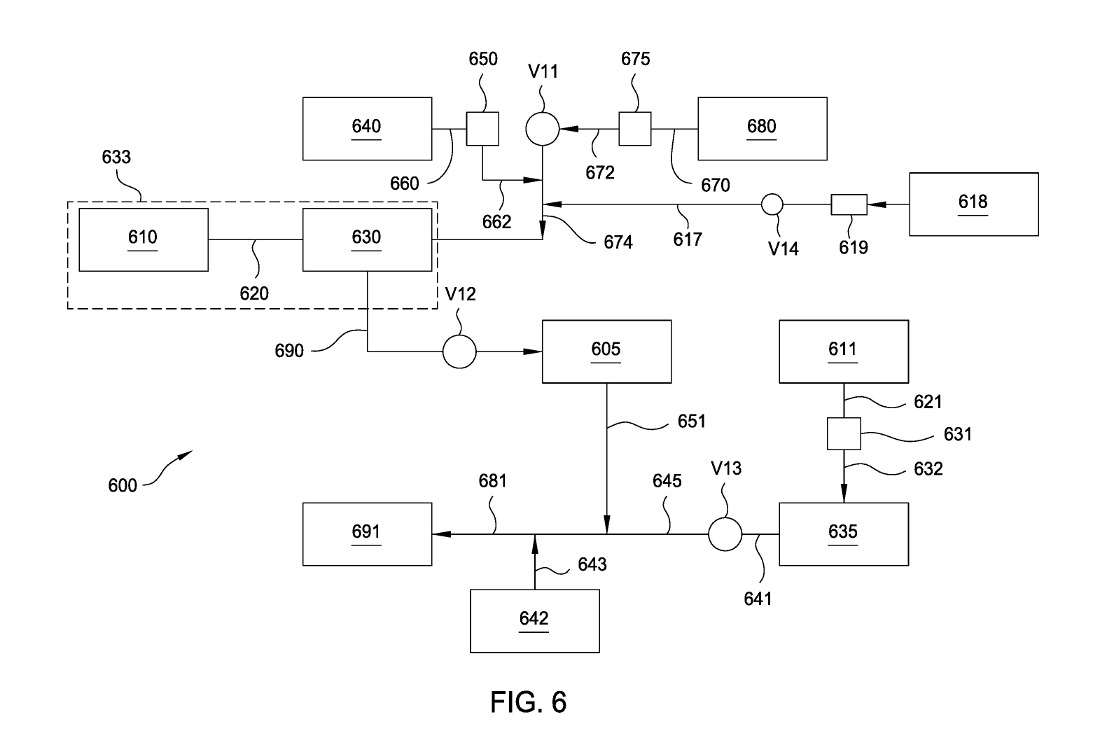

FIG. 6 is a schematic view of a fracturing fluid system 600 according to one embodiment. The system 600 includes a Y-Grade NGL storage unit 680, a non-aqueous based chemical unit 640, and a pressurized proppant storage unit 610 each fluidly coupled to a pressurized receiver blender 630 (such as pressurized receiver blender 60 shown in FIG. 1) by at least one of piping 620 and 674. In one embodiment, the pressurized proppant storage unit 610 and the pressurized receiver blender 630 can be combined into a mobile, integrated storage vessel comprising a pressurized proppant blender unit 633.

The system 600 further includes a high pressure pump 605, a liquid nitrogen source 611, a cryogenic pump 631, and a vaporizer 635. In one embodiment, the vaporizer 635 may be a heat recovery unit (“HRU”). The system 600 is configured to form a fracturing fluid for injection into a subsurface formation, such as a hydrocarbon bearing reservoir, via a wellhead 691. The system 600 further includes a secondary fluid unit 618 configured to supply one or more secondary fluids to be mixed with the fluids in piping 674 via a pump 619, a control valve V14, and piping 617.

Y-Grade NGL from the Y-grade NGL storage unit 680 is transferred to a pump 675 through piping 670, to a control valve V11 through piping 672, and to the pressurized receiver blender 630 (or the pressurized proppant blender unit 633) through piping 674. The non-aqueous based chemical unit 640 can supply one or more non-aqueous based chemical agents to a pump 650 through piping 660.

The non-aqueous based chemical unit 640 is connected to the pump 650 by piping 660, and the pump 650 is connected to piping 674 by piping 662. A non-aqueous based chemical agent is transferred from the chemical unit 640 (through piping 660, the pump 650, and piping 662) into piping 674 and to the pressurized receiver blender 630 (or the pressurized proppant blender unit 633). Also, a secondary fluid may be transferred from the secondary fluid unit 618 (through piping 617, the pump 619, and the control valve V14) into piping 674 and to the pressurized receiver blender 630 (or the pressurized proppant blender unit 633). Proppant from the proppant storage unit 610 is supplied via piping 620 into the pressurized receiver blender 630.

The pressurized receiver blender 630 or the pressurized proppant blender unit 633 receives the Y-Grade NGL, the non-aqueous based chemical agent, the secondary fluid, and the proppant (from proppant storage unit 610 via piping 620) and mixes them together to form a fracturing fluid, such as a proppant-laden fracturing fluid. The pressurized receiver blender 630 or the pressurized proppant blender unit 633 is typically maintained at a pressure of about 250 psig to about 600 psig, for example about 500 psig. The pressurized receiver blender 630 or the pressurized proppant blender unit 633 is a mixing vessel, which may be made from any convenient variety of steel, such as carbon steel. The pressurized receiver blender 630 or the pressurized proppant blender unit 633 may include an abrasion resistant lining, which may include a fluoropolymer such as Teflon. Mixing in the pressurized receiver blender 630 or the pressurized proppant blender unit 633 may be performed using a pumparound.

The viscosity of the fracturing fluid may be controlled by adjusting the pump 650. The liquid level in the pressurized receiver blender 630 may be controlled by adjusting the flow rates of the Y-Grade NGL, the non-aqueous based chemical agent, the secondary fluid, and/or the proppant into the pressurized receiver blender 630. Alternately, the flow rates of the Y-Grade NGL, the non-aqueous based chemical agent, the secondary fluid, and/or the proppant may be set by recipe control by a pumping schedule.

Alternatively, when the pressurized proppant blender unit 633 is used, the Y-Grade NGL chemical stream flows through piping 674 underneath the pressurized proppant blender unit 633 (such as a silo) where the proppant is introduced into the pressurized Y-Grade NGL chemical stream via an eductor, which is then discharged into the pressurized proppant blender unit 633, such as via piping 620.

The fracturing fluid is transferred from the pressurized receiver blender 630 or alternatively from the pressurized proppant blender unit 633 through piping 690 and a control valve V12 into the suction of one or more high-pressure pumps 605, which are typically reciprocating pumps, fluidly coupled to an effluent portal of the pressurized receiver blender 630 or the pressurized proppant blender unit 633. The high-pressure pumps 605 boost pressure of the fracturing fluid to a wellhead pressure up to 10,000 psig or greater and discharge the pressurized fracturing fluid through piping 651.

Liquid nitrogen obtained from the liquid nitrogen source 611 is transferred to one or more cryogenic pumps 631 through piping 621. The liquid nitrogen source 611 may comprise air separation equipment configured to separate nitrogen from air to supply nitrogen to the liquid nitrogen source 611. The air separation equipment may be an ECOGAN™ modular air separation plant. The cryogenic pumps 631 discharge the liquid nitrogen through piping 632 into the vaporizer 635 where the liquid nitrogen is converted into high pressure gaseous nitrogen. Alternatively, the liquid nitrogen can be supplied from the liquid nitrogen source 611 directly into a heat recovery unit (HRU) and discharged directly into piping 641 upstream of a control valve V13.

The high pressure gaseous nitrogen is discharged via piping 641 to the control valve V13, and from the control valve V13 through piping 645 directly into piping 681, where it mixes with and cools the pressurized fluids from piping 651 to generate a hydrocarbon foam. The hydrocarbon foam, also referred to as a fracturing fluid, for example a proppant laden fracturing fluid, is then supplied into the wellhead 691 for injection into the subsurface formation.

The quality of the hydrocarbon foam may be between about 55% to about 95%. Although the fracturing fluid systems are described herein with respect to liquid nitrogen converted into high pressure gaseous nitrogen, the fracturing fluid systems can be used to form foamed fracturing fluids with other gases, including but not limited carbon dioxide, natural gas, methane, LNG, and/or ethane.

Prior to injection into the subsurface formation, optionally a diverting agent supplied from a diverting agent unit 642 may be injected into piping 681 via piping 643. The diverting agent is suspended within the fluids, such as the hydrocarbon foam, in piping 681 to form the fracturing fluid that is injected into the subsurface formation via the wellhead 691. The subsurface formation may have been previously perforated at one or more locations (forming multiple perforation clusters) along the length of the wellbore that extends through the subsurface formation.

The diverting agent temporarily blocks flow through one or more perforation clusters that are preferentially accepting the fracturing fluid to help introduce fluid flow into one or more other perforation clusters that previously had not accepted the fracturing fluid. The temporary blocking of flow improves the distribution of the fracturing fluid across the entire clusters of perforations. At the conclusion of the fracturing, the diverting agent either dissolves, biodegrades, and/or is removed from the perforation clusters via gravity, pressure surge, hydraulically, mechanically, and/or other displacement means.

The diverting agent may include at least one of a mechanical diverting agent, a chemical diverting agent, and/or a nanoparticle based diverting agent. An example of a mechanical diverting agent includes ball sealers. The diverting agent may be formed out of a biodegradable, fluid sensitive, and/or temperature sensitive material. For example, the diverting agent may be rock salt that solubilizes when exposed to water in the subsurface formation. The diverting agent can be fashioned in any shape that corresponds to the shape of the perforation channel to temporarily plug and divert the fracturing fluid to other perforation channels in the same or different perforation clusters.

The piping 621 and 632 may be resistant to cryogenic temperatures. The cryogenic pump 631 may have one or more parts that contact the process fluids and are therefore made of cryogenic alloys such as stainless steel, Inconel, and/or austenitic stainless steel. The low temperature equipment of FIG. 6, such as the piping 621 and 632, the liquid nitrogen source 611, the cryogenic pump 631, and/or the vaporizer 635 may be insulated.

Alternatively, the system 600 can be used to form a gelled fracturing fluid without the addition of high pressure gaseous nitrogen. The non-aqueous based chemical agent may comprise a gelling agent, which is combined with the Y-Grade NGL, optionally a secondary fluid, and proppant in the pressurized receiver blender 630 (or the pressurized proppant blender unit 633) to form the gelled fracturing fluid. No high pressure gaseous nitrogen is added to the gelled fracturing fluid prior to injection into the wellhead 691.

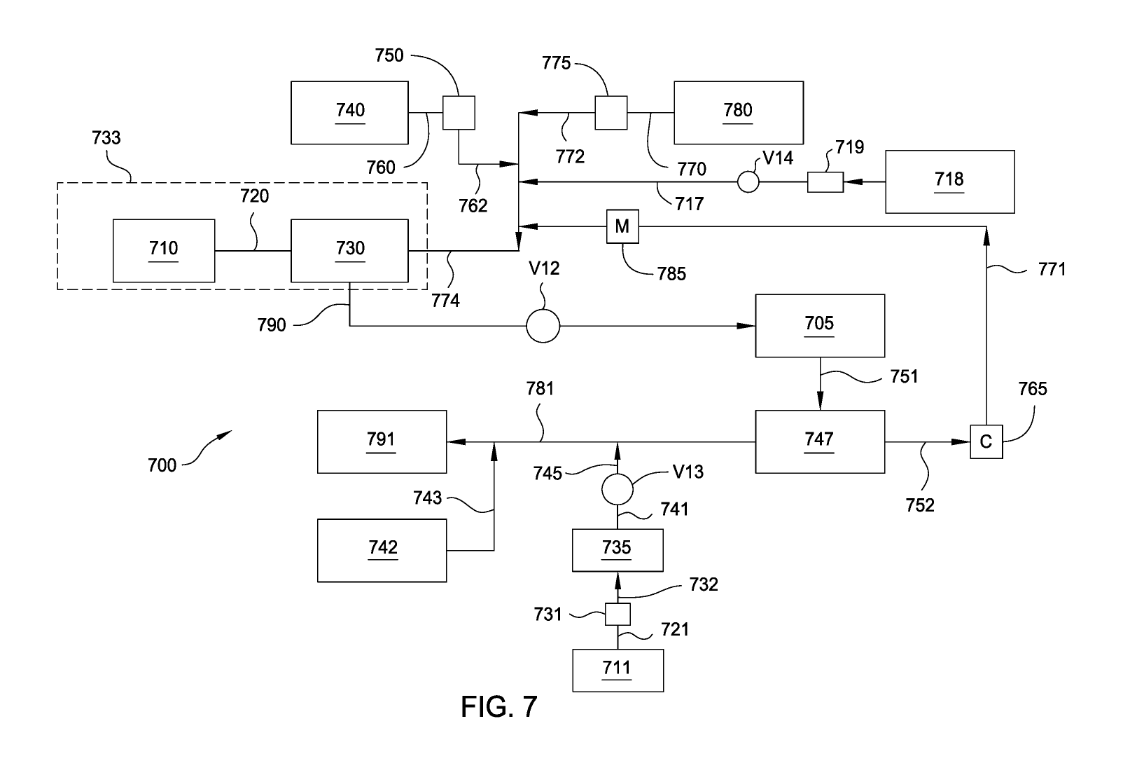

FIG. 7 is a schematic view of a fracturing fluid system 700 according to one embodiment. The components of the fracturing fluid system 700 that are similar to the components of the fracturing fluid system 600 have the same base reference number but are designated under “700's”. The system 700 is similar to the fracturing fluid system 600 with one difference being that a concentrator 747 has been installed onto piping 751 from the high-pressure pump 705 to remove (via centrifugal separation for example) excess Y-Grade NGL, thus concentrating the remaining mass of proppant in the pressurized fluids that are discharged into piping 781. Excess Y-Grade NGL is removed from the concentrator 747 through piping 752. A choke assembly 765 reduces fluid pressure to enable Y-Grade NGL recycling. Y-Grade NGL discharged from the choke assembly 765 flows through piping 771 where it is metered by turbine-meter 785 and recycled back into the pressurized receiver blender 730 or the pressurized proppant blender unit 733 as described above via piping 774.

Liquid nitrogen obtained from the liquid nitrogen source 711, which may be a liquid nitrogen storage unit, is transferred via piping 721 to one or more cryogenic pumps 731. The cryogenic pump 731 discharges liquid nitrogen through piping 732 into the vaporizer 735, which converts the liquid nitrogen to high pressure gaseous nitrogen. Alternatively, the liquid nitrogen can be supplied from the liquid nitrogen source 711 directly into a heat recovery unit (HRU) and discharged directly into piping 741 upstream of the control valve V13. The high pressure gaseous nitrogen exits the vaporizer 735 or the HRU via piping 741 into the control valve V13, and from the control valve V13 through piping 745 directly into piping 781, where it mixes with and cools the concentrated, pressurized fluids in piping 781 to generate a hydrocarbon foam.

The hydrocarbon foam, also referred to as a fracturing fluid, is then supplied into the wellhead 791 for injection into a subsurface formation, such as a hydrocarbon bearing reservoir. The diverting agent from the diverting agent unit 742 may optionally be injected into piping 781 via piping 743 for suspension in the fracturing fluid as described above prior to injection into the subsurface formation. Similarly as described above, a gelled fracturing fluid can be formed using the system 700 by using a gelling agent and by not adding any high pressure gaseous nitrogen to the gelled fracturing fluid.

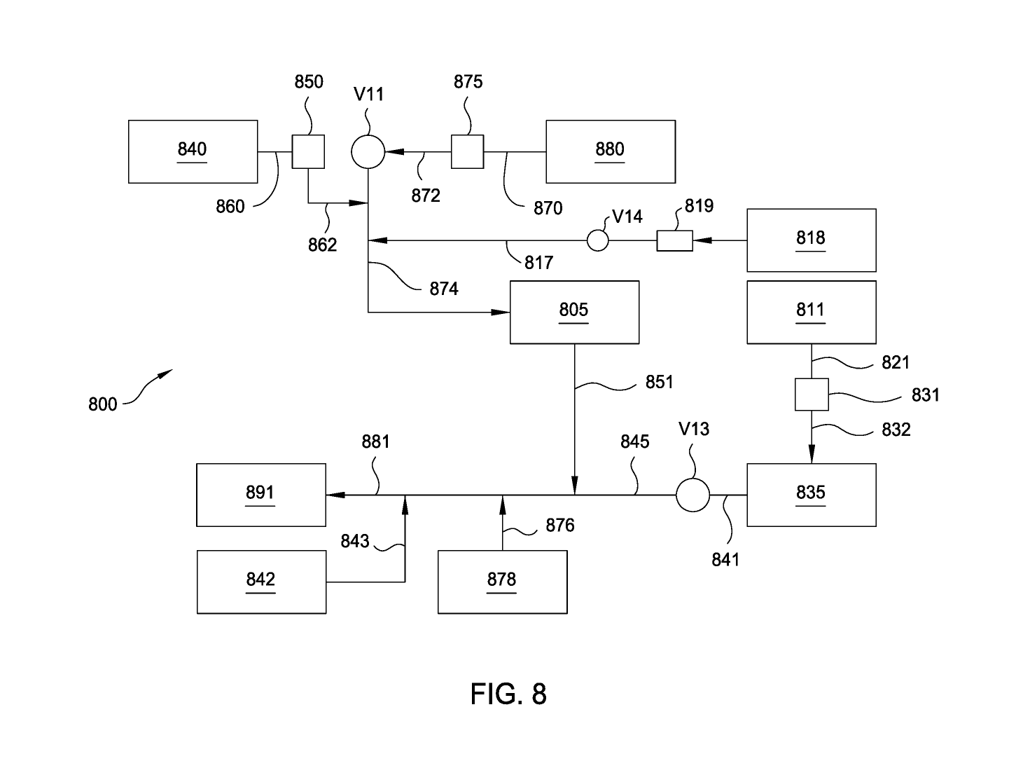

FIG. 8 is a schematic view of a fracturing fluid system 800 according to one embodiment. The components of the fracturing fluid system 800 that are similar to the components of the fracturing fluid system 600 have the same base reference number but are designated under “800's”. The system 800 is similar to the fracturing fluid system 600, with one difference being that a pressurized proppant system 878 has been added downstream of the high pressure pump 805 to replace the proppant storage unit 610 and the pressurized receiver blender 630 (or the pressurized proppant blender unit 633).

The system 800 includes the Y-Grade NGL storage unit 880, the pump 875, the non-aqueous based chemical unit 840, the pump 850, the secondary fluid unit 818, one or more high-pressure pumps 805, the liquid nitrogen source 811, one or more cryogenic pumps 831, the vaporizer 835 (or alternatively the HRU), and the pressurized proppant system 878. Y-Grade NGL from the Y-Grade NGL storage unit 880 is transferred via pump 875 to piping 874, where it is mixed with a non-aqueous based chemical agent supplied from the non-aqueous based chemical unit 840, optionally a secondary fluid supplied from the secondary fluid unit 818, and transferred to piping 874 via pump 850. The mixture in piping 874 flows through the high-pressure pump 805, which boosts the pressure of the mixture and discharges the mixture to piping 881 via piping 851.

Liquid nitrogen obtained from the liquid nitrogen source 811, which may be a liquid nitrogen storage unit, is transferred via piping 821 to one or more cryogenic pumps 831. The cryogenic pumps 831 discharge the liquid nitrogen through piping 832 into the vaporizer 835, which converts the liquid nitrogen to high pressure gaseous nitrogen. Alternatively, the liquid nitrogen can be supplied from the liquid nitrogen source 811 directly into a heat recovery unit (HRU) and discharged directly into piping 841 upstream of the control valve V13. The high pressure gaseous nitrogen exits the vaporizer 835 or the HRU via piping 841 into the control valve V13, and flows from the control valve V13 through piping 845 directly into piping 881 where it mixes with and cools the pressurized fluids to generate a hydrocarbon foam.

Pressurized proppant from the pressurized proppant system 878 is injected via piping 876 into the hydrocarbon foam in piping 881. The proppant-laden hydrocarbon foam, also referred to as a fracturing fluid, is then supplied into the wellhead 891 for injection into a subsurface formation, such as a hydrocarbon bearing reservoir. The diverting agent from the diverting agent unit 842 may optionally be injected into piping 881 via piping 843 for suspension in the fracturing fluid as described above prior to injection into the subsurface formation. Similarly as described above, a gelled fracturing fluid can be formed using the system 800 by using a gelling agent and by not adding any high pressure gaseous nitrogen to the gelled fracturing fluid.

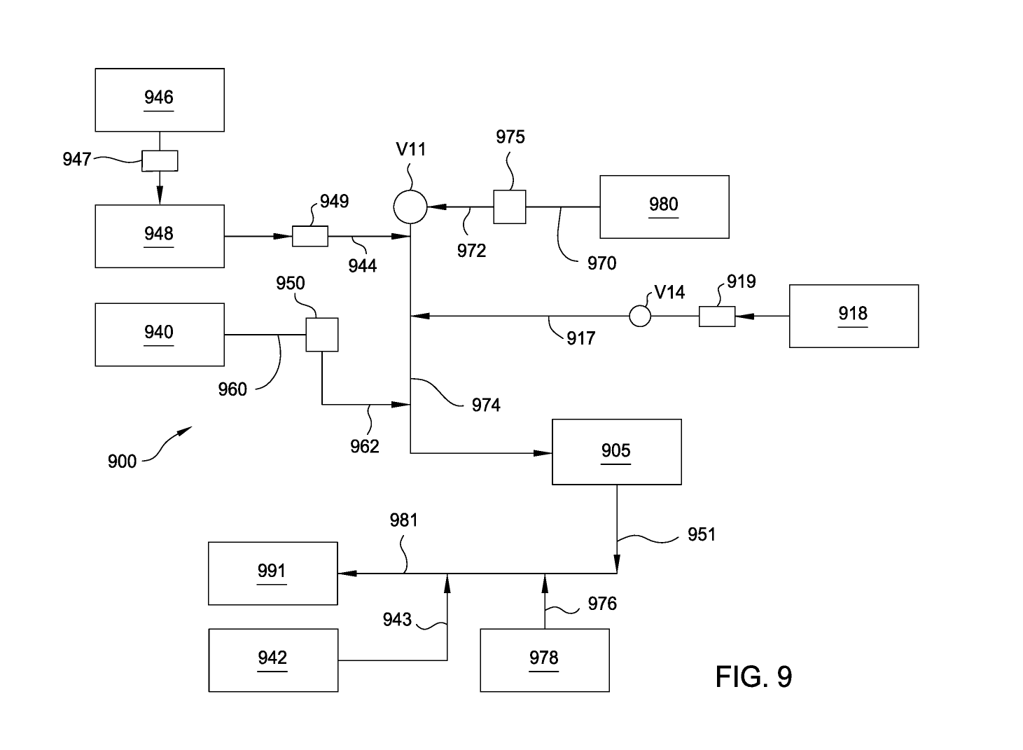

FIG. 9 is a schematic view of a fracturing fluid system 900 according to one embodiment. The components of the fracturing fluid system 900 that are similar to the components of the fracturing fluid system 800 have the same base reference number but are designated under “900's”. The system 900 is similar to the fracturing fluid system 800, with one difference being that the liquid nitrogen source 811, the cryogenic pumps 831, the vaporizer 835 (or the HRU), and the control valve V13 have been removed, and an aqueous based chemical unit 946, a pump 947, a water source 948, and an injection pump 949 have been added to form an emulsion based fracturing fluid.

The system 900 includes the Y-Grade NGL storage unit 980, the pump 975, the non-aqueous based chemical unit 940, the pump 950, one or more high-pressure pumps 905, the pressurized proppant system 978, and optionally the diverting agent unit 942. Y-Grade NGL from the Y-Grade NGL storage unit 980 is transferred via pump 975 to piping 974, through valve V11 and line 972, where it is mixed with a non-aqueous based chemical agent supplied from the non-aqueous based chemical unit 940 and transferred to piping 974 via pump 950 and piping 960 and 962.

One or more aqueous based chemicals from the aqueous based chemical unit 946 are supplied into the water source 948 via pump 947 to form a chemical/water mixture. The volume of aqueous based chemicals is based on a set formula and is less than 10% by volume when mixed with the water from the water source 948. The water in the water source 948 may be brine, seawater, and/or formation water. The water in the water source 948 may be fresh water inhibited with potassium chloride. The potassium chloride water may comprise up to 4% potassium chloride.

The chemical/water mixture is pumped via injection pump 949 and piping 944 into piping 974 downstream of the pump 950 where the chemical/water mixture is combined and mixed with the non-aqueous based chemical agent from the non-aqueous based chemical agent tank 940, the Y-Grade NGL from the Y-Grade NGL storage unit 980, and optionally one or more secondary fluids from the secondary fluid unit 918 to form an emulsion. The water may comprise up to 25% of the liquid phase of the emulsion. The emulsion is then pumped by high pressure pump 905 into piping 951, piping 981, and the wellhead 991.

Pressurized proppant from the pressurized proppant system 978 is injected via piping 976 into the emulsion in piping 981. The proppant-laden emulsion, also referred to as a fracturing fluid, is then supplied into the wellhead 991 for injection into a subsurface formation, such as a hydrocarbon bearing reservoir. The diverting agent from the diverting agent unit 942 may optionally be injected into piping 981 via piping 943 for suspension in the fracturing fluid as described above prior to injection into the subsurface formation.

In an alternative embodiment, instead of a pressurized proppant system 978, the system 900 may include a pressurized proppant blender unit (similar to the pressurized proppant blender unit 733 as described above with respect to system 700) located upstream of the high pressure pump 905. In this alternative embodiment, the system 900 may also include a concentrator (similar to the concentrator 747 as described above with respect to system 700) located downstream of the high pressure pump 905 to remove excess Y-Grade NGL, thus concentrating the proppant in the the remaining emulsion that is discharged into piping 981.

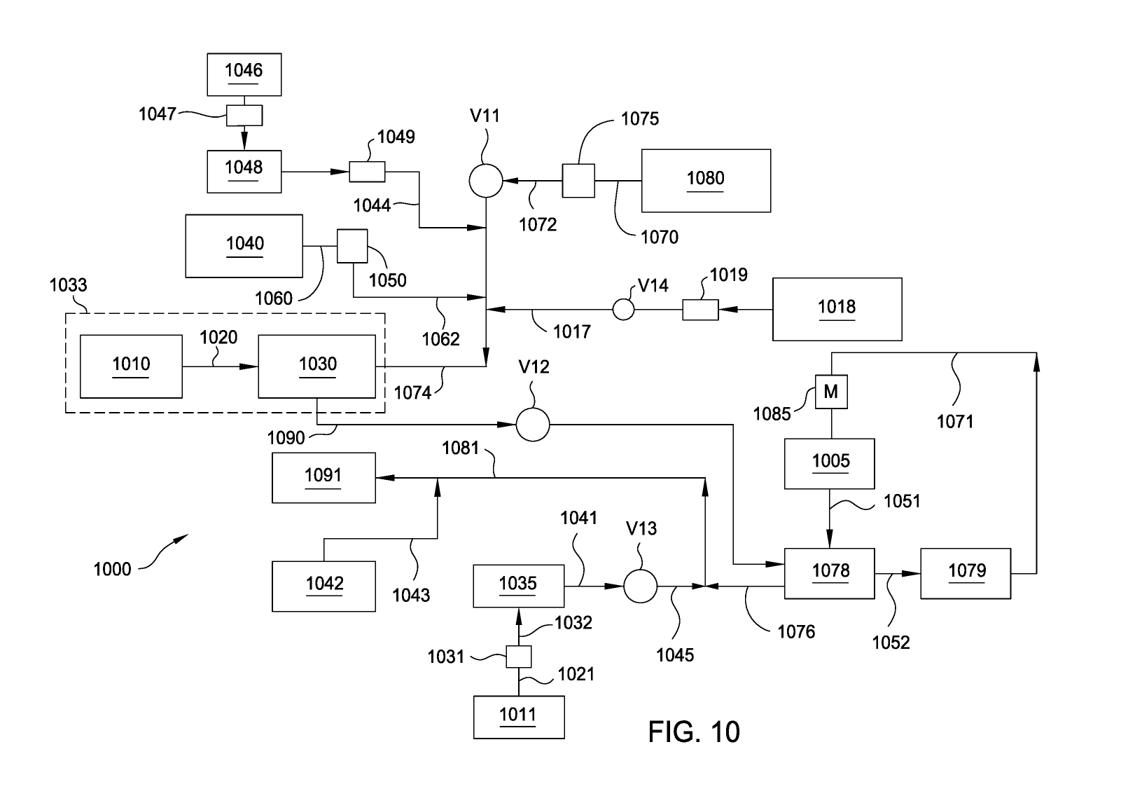

FIG. 10 is a schematic view of a fracturing fluid system 1000 according to one embodiment. The components of the fracturing fluid system 1000 that are similar to the components of the fracturing fluid system 600 have the same base reference number but are designated under “1000's”. The system 1000 is similar to the fracturing fluid system 600, with one difference being a VorTeq™ hydraulic pumping system 1078 that has been added to form a closed loop so that the proppant-laden mixture from the pressurized receiver blender 1030 or pressurized proppant blender unit 1033 does not flow through the high-pressure pump 1005, and an aqueous based chemical unit 1046, a pump 1047, a water source 1048, and an injection pump 1049 have been added to form an emulsion based foam as the fracturing fluid.

The system 1000 includes the Y-Grade NGL storage unit 1080, the pump 1075, the non-aqueous based chemical unit 1040, the optional secondary fluid unit 1018, the pump 1050, the proppant storage unit 1010, the pressurized receiver blender 1030 (or pressurized proppant blender unit 1033), one or more high-pressure pumps 1005, the liquid nitrogen source 1011, one or more cryogenic pumps 1031, the vaporizer 1035, the VorTeq system 1078, and optionally the diverting agent unit 1042. Y-Grade NGL from the Y-Grade NGL storage unit 1080 is transferred via pump 1075 to piping 1074, where it is mixed with a non-aqueous based chemical agent supplied from the non-aqueous based chemical unit 1040 and optionally a secondary fluid supplied from the secondary fluid unit 1018.

One or more aqueous based chemicals from the aqueous based chemical unit 1046 are supplied into the water source 1048 via pump 1047 to form a chemical/water mixture. The volume of aqueous based chemicals is based on a set formula and less than 10% by volume when mixed with the water from the water source 1048. The water from the water source 1048 may be brine, seawater, and/or formation water. The water from the water source 1048 may be fresh water inhibited with potassium chloride. The potassium chloride water may comprise up to 4% potassium chloride.

The chemical/water mixture is pumped via injection pump 1049 and piping 1044 into piping 1074 downstream of the pump 1050 where the chemical/water mixture is combined and mixed with the non-aqueous based chemical agent from the chemical agent tank 1040, the Y-Grade NGL from the Y-Grade NGL storage unit 1080, and optionally the secondary fluid from the secondary fluid unit 1018, which mixture is then pumped through the pressurized receiver blender 1030 (or pressurized proppant blender unit 1033) and into the VorTeq system 1078.

The Y-Grade NGL and chemical mixture is mixed with proppant from the proppant storage unit 1010 in the pressurized receiver blender 1030 or the pressurized proppant blender unit 1033. The proppant-laden mixture from the pressurized receiver blender 1030 or the pressurized proppant blender unit 1033 flows through the VorTeq system 1078 (via piping 1090), which pressurizes the proppant-laden mixture using a pressurized fluid (also referred to as a power fluid) supplied from the high-pressure pumps 1005 to the VorTeq system 1078 via piping 1051. The VorTeq system 1078 minimizes fluid contact between the power fluid and the proppant-laden mixture, while transferring the hydraulic pressure to boost the pressure of the proppant-laden mixture.

The now pressurized proppant-laden mixture discharges to piping 1076, and the expended power fluid discharges through piping 1052 to a separator 1079, which separates out any solid material that may have mixed into the expended power fluid. From the separator 1079, the expended power fluid is metered by turbine-meter 1085 and cycled back to the high-pressure pumps 1005 via piping 1071 to be re-pressurized. The re-pressurized power fluid that cycles through the closed loop, including the high-pressure pumps 1005, the VorTeq system 1078, and the separator 1079, may comprise Y-Grade NGL, diesel, or any other hydrocarbon based fluid.

Liquid nitrogen obtained from the liquid nitrogen source 1011, which may be a liquid nitrogen storage unit, is transferred via piping 1021 to one or more cryogenic pumps 1031. The cryogenic pumps 1031 discharge the liquid nitrogen through piping 1032 into the vaporizer 1035, which converts the liquid nitrogen to high pressure gaseous nitrogen. Alternatively, the liquid nitrogen can be supplied from the liquid nitrogen source 1011 directly into a heat recovery unit (HRU) and discharged directly into piping 1041 upstream of the control valve V13. The high pressure gaseous nitrogen exits the vaporizer 1035 or the HRU via piping 1041 into the control valve V13, and flows from the control valve V13 through piping 1045 into piping 1081 where it mixes with and cools the pressurized, proppant-laden mixture to generate an emulsion based foam.

The proppant-laden emulsion based foam (also referred to as a fracturing fluid) is then supplied into the wellhead 1091 for injection into a subsurface formation, such as a hydrocarbon bearing reservoir. The diverting agent from the diverting agent unit 1042 may optionally be injected into piping 1081 via piping 1043 for suspension in the fracturing fluid prior to injection into the subsurface formation. The water may comprise up to 25% of the liquid phase of the emulsion based foam.

In an alternative embodiment, the one or more high pressure pumps 1005 may be used without the VorTeq system 1078, the separator 1079, and/or the turbine-meter 1085 to discharge the fluid directly into the piping 1081 for mixture with the high pressure gaseous nitrogen to form the emulsion based foam. In this alternative embodiment, the system 1000 may also include a concentrator (similar to the concentrator 747 as described above with respect to system 700) located downstream of the high pressure pumps 1005 to remove excess Y-Grade NGL, thus concentrating the proppant in the remaining fluids that are discharged into piping 1081.

Any of the systems disclosed herein may include a VorTeq™ system (developed by Energy Recovery, Inc.) to protect the high-pressure pumps, such as high-pressure pumps, from abrasion damage that may be caused by flowing proppant-laden fluid through the high-pressure pumps. Using the VorTeq system, proppant may be routed away from and by-pass the high-pressure pumps. In one embodiment, the high-pressure pumps of any of the systems disclosed herein may be cementing units.

Any of the systems disclosed herein may include Y-Grade NGL storage tanks that comprise of onsite Y-Grade NGL pressurized storage vessels that are supplied from a regional Y-Grade NGL gathering pipeline, a regional gas splitter, or a gas processing facility via tanker trucks. Any of the systems disclosed herein may include proppant that can be temporally stored in the pressurized proppant silo and pneumatically conveyed using a pressurized gas, such as nitrogen and/or carbon dioxide.

The fracturing fluids provided by any of the systems disclosed herein may be injected into a subsurface formation, such as a hydrocarbon bearing reservoir, at a pressure that overcomes the rock mechanical properties of the subsurface formation to fracture the rock formation. In some cases, the pressure needed to fracture the rock formation is about 7,000 psig, but pressures may exceed 10,000 psig or greater to create fractures at greater depths. As the fracturing fluid is pumped into the rock formation, pressure builds as the rock formation is pressurized with the fracturing fluid and flow areas become increasingly restricted until the natural stress within the rock formation is exceeded. When pressure within the rock formation reaches a critical point, sometimes referred to as “breakdown pressure,” fractures begin to nucleate and grow within the rock formation. When the rock formation begins to yield, pressure may drop to a fracture propagation range.

The fracturing fluids provided by any of the systems disclosed herein may be injected into a subsurface formation at a temperature that cools and lowers the temperature of the rock of the subsurface formation to fracture the rock formation. In some cases, the rock of the subsurface formation may have been previously fractured by hydraulic fracturing, and the cooling (or thermal shock) provided by the fracturing fluid creates additional fractures in the rock of the subsurface formation. In some cases, the fracturing fluid may be injected into the subsurface formation at a temperature that cools and lowers the temperature of the rock of the subsurface formation but does not fracture the rock formation.

The fracturing fluids provided by any of the systems disclosed herein may comprise a proppant. The proppant supplied from the proppant storage unit, the pressurized proppant blender unit, or the pressurized proppant system may be optionally added to any of the fracturing fluids. The proppant may include sand and/or ceramic materials. The proppant may include natural sand, a resin coated sand, a ceramic material, or a resin coated ceramic material. The proppant supplied may be “bone dry” (e.g. substantially free from any liquid, such as water) when mixed to form the fracturing fluid.

The fracturing fluids, such as the hydrocarbon foam, the emulsion based foam, the emulsion, and the gelled fracturing fluids, provided by any of the systems disclosed herein may comprise non-aqueous based chemical agents supplied by the non-aqueous based chemical units. The non-aqueous based chemical agents include but are not limited to non-aqueous based foaming agents, foam stabilizers, emulsifying agents, gelling agents, viscosity increasing agents, surfactants, nanoparticles, and combinations thereof.

The fracturing fluids, such as the emulsion based foam and the emulsion, provided by any of the systems disclosed herein may comprise aqueous based chemical agents supplied by the aqueous based chemical units. The aqueous based chemical agents include but are not limited to aqueous based foaming agents, foam stabilizers, emulsifying agents, gelling agents, viscosity increasing agents, surfactants, nanoparticles, breakers, friction reducers, scale inhibiters, biosides, acids, buffer/pH adjusting agents, clay stabilizers, corrosion inhibiters, crosslinkers, iron controls, solvents, and combinations thereof.

The fracturing fluids, such as the hydrocarbon foam and the emulsion based foam, provided by any of the systems disclosed herein may comprise foaming agents. The foaming agents include but are not limited to nonionic surfactants, wherein the nonionic surfactants comprise at least one of a siloxane surfactant, a fluorosurfactant, a fatty acid ester, a glyceride, a silicon emulsifier, and a hydrophobic silica powder.

The foaming agents for the hydrocarbon foam and/or the emulsion based foam may also include but are not limited to surfactants, such as ionic surfactants, nonionic surfactants, anionic surfactants, cationic surfactants, iC90-glycol, iC10-glycol, 1-propanol, iso-propanol, 2-butanol, butyl glycol, sulfonic acids, betaine compounds, fluorosurfactants, hydrocarbon solvents, aluminum soaps, phosphate esters, alcoholethersulfates, alcohol sulfate, alcylsulfates, isethionates, sarconisates, acylsarcosinates, olefinsulfonates, alcylethercarboxylates, alcylalcoholam ides, aminoxids, alkylbenzolsulfonate, alkylnaphthalene sulfonates, fattyalcohol ethoxylates, oxo-alcohol ethoxylates, alkylethoxylates, alkylphenolethoxylates, fattyamin- and fattyamidethoxylates, alkylpolyglucosides, oxoalcohol ethoxylates, guerbetalcohol alkoxylates, alkylethersulfonate, EO/PO blockpolymers, betaines, cocamidopropylbetaine, C8-C10 alkylamidopropylbetaine, sulfobetaines, alkenylsulfonates, alkylglykols, alcoholalkoxylates, sulfosuccinates, alkyletherphosphates, esterquats, dialcylammoniumderivatives, trialcylammoniumderivatives, and combinations thereof.

The fracturing fluids, such as the hydrocarbon foam and the emulsion based foam, provided by any of the systems disclosed herein may comprise foam stabilizers. The foam stabilizers include but are not limited to proteins, microparticles, nanoparticles, silica, and silica derivatives that are known to stabilize foam and emulsions through so-called “pickering”. The foam stabilizers may comprise additives that increase the viscosity of the fracturing fluid composing the lamella, such as polymeric structures.

The fracturing fluids, such as the gelled fracturing fluids, provided by any of the systems disclosed herein may comprise nonaqueous gelling agents. The gelling agents include but are not limited to hydrocarbon soluble copolymers, phosphate esters, organo-metallic complex cross-linkers, amine carbamates, alumunin soaps, cocoamine (C12-C14), sebacoyl chloride, oley (C18) amine, toulen-2,4-diisocyanate, tolune-2,6-diisolcyanate, and combinations thereof.

The fracturing fluids, such as the hydrocarbon foam, the emulsion based foam, the emulsion, and the gelled fracturing fluids, provided by any of the systems disclosed herein may comprise secondary fluids. The secondary fluids include but are not limited to aromatics, alkanes, crude oils, and combinations thereof. The secondary fluid may comprises 10% or less by volume of the fracturing fluids described herein. The aromatics may comprise at least one of benzene, naphtha, xylene, toluene, fuel oils, olefins, and diesel. The alkanes may comprise at least one of heptane, octane, and hexane. The crude oil may comprise at least one of NGL's, condensate, light oil, and medium oil.

The fracturing fluids provided by any of the systems disclosed herein may comprise an unfractionated hydrocarbon mixture comprising ethane, propane, butane, isobutane, and pentane plus, wherein the ethane, propane, and butane comprise at least 75% by volume of the unfractionated hydrocarbon mixture.

The fracturing fluids provided by any of the systems disclosed herein may comprise an unfractionated hydrocarbon mixture comprising ethane, propane, butane, isobutane, and pentane plus, wherein the ethane comprises at least 3% by volume of the unfractionated hydrocarbon mixture.

The fracturing fluids provided by any of the systems disclosed herein may comprise an unfractionated hydrocarbon mixture comprising ethane, propane, butane, isobutane, and pentane plus, wherein the pentane plus comprises less than 30% by volume of the unfractionated hydrocarbon mixture.

The foamed fracturing fluids provided by any of the systems disclosed herein may be formed with any type of gas, such as carbon dioxide, nitrogen, natural gas, methane, LNG, and/or ethane, and include one or more foaming agents, such as a surfactant, to form a hydrocarbon foam. The gas content of the fracturing fluid may be between about 55% to about 95% by volume. The nitrogen content of a hydrocarbon or emulsion based foam created by any of the systems disclosed herein may be greater than 50% by volume, and the carbon dioxide content of a hydrocarbon or emulsion based foam created by any of the systems disclosed herein may be greater than 35% by volume, which causes the resulting gaseous mixtures to be outside the Flammability Limit, sometimes referred to as the Explosion Limit in which a flammable substance such as Y-Grade NGL in the presence of air can produce a fire or explosion when an ignition source such as a spark or open flame is present.

The fracturing fluids provided by any of the systems disclosed herein may be injected into a subsurface formation at a low temperature, such as at or below about 0 degrees Fahrenheit, for example as low as −30 degrees Fahrenheit.

In one embodiment, a fracturing fluid comprises a proppant; an unfractionated hydrocarbon mixture comprising ethane, propane, butane, isobutane, and pentane plus, wherein the unfractionated hydrocarbon mixture is a byproduct of a condensed and de-methanized hydrocarbon stream, wherein the unfractionated hydrocarbon mixture comprises ethane, propane, and butane in an amount of at least 75% by volume, and wherein the unfractionated hydrocarbon mixture comprises pentane plus in an amount less than 30% by volume; and a chemical agent. The unfractionated hydrocarbon mixture is condensed out of the hydrocarbon stream at a temperature at or below 0 degrees Fahrenheit. The unfractionated hydrocarbon mixture comprises ethane in an amount of at least 3% by volume.

In one embodiment, the fracturing fluid further comprises a gas, wherein the chemical agent comprises a foaming agent, and wherein the gas, the foaming agent, and the unfractionated hydrocarbon mixture are combined to form a hydrocarbon foam. The gas comprises at least one of carbon dioxide, nitrogen, natural gas, methane, LNG, and ethane. The foaming agent comprises a nonionic surfactant, wherein the nonionic surfactant comprises at least one of a siloxane surfactant, a fluorosurfactant, a fatty acid ester, a glyceride, a silicon emulsifier, and a hydrophobic silica powder. The nonionic surfactant comprises a mass concentration of up to 5%. The chemical agent further comprises a foam stabilizer, wherein the foam stabilizer is a hydrocarbon soluble copolymer. The chemical agent further comprises nanoparticles. The hydrocarbon foam further comprises at least one of a mechanical diverting agent and a chemical diverting agent.

The hydrocarbon foam further comprises a secondary fluid, wherein the secondary fluid comprises at least one of aromatics, alkanes, and crude oil, and wherein the secondary fluid comprises 10% or less by volume of the fracturing fluid. The aromatics comprise at least one of benzene, naphtha, xylene, toluene, fuel oils, olefins, and diesel. The alkanes comprise at least one of heptane, octane, and hexane. The crude oil comprises at least one of NGL's, condensate, light oil, and medium oil.

In one embodiment, the fracturing fluid further comprises water and a gas, wherein the chemical agent comprises a surfactant, and wherein the unfractionated hydrocarbon mixture, the water, the gas, and the surfactant are combined to form an emulsion based foam. The surfactant acts as a foaming agent, an emulsifying agent, or both. The water is brine, seawater, and/or formation water and comprises up to 25% of the liquid phase of the emulsion based foam. The water is fresh water inhibited with potassium chloride and comprises up to 25% of the liquid phase of the emulsion based foam. The fresh water inhibited with potassium chloride comprises up to 4% potassium chloride. The gas comprises at least one of nitrogen, carbon dioxide, natural gas, methane, LNG, and ethane. The chemical agent further comprises a foam stabilizer, wherein the foam stabilizer is a hydrocarbon or water soluble copolymer. The chemical agent further comprises nanoparticles. The emulsion based foam further comprises at least one of a mechanical diverting agent and a chemical diverting agent.

The surfactant comprises a mass concentration of up to 5% of the emulsion based foam. The surfactant comprises at least one of a nonionic surfactant, an anionic surfactant, and a cationic surfactant. The nonionic surfactant comprises at least one of a siloxane surfactant, a fluorosurfactant, a fatty acid ester, a glyceride, a silicon emulsifier, and a hydrophobic silica powder.

The anionic surfactant comprises at least one of 2-Acrylamido-2-methylpropane sulfonic acid, ammonium lauryl sulfate, ammonium perfluorononanoate, docusate, magnesium laureth sulfate, MBAS assay, perfluorobutanesulfonic acid, perfluorononanoic acid, perfluorooctanesulfonic acid, perfluorooctanoic acid, phospholipid, potassium lauryl sulfate, soap, soap substitute, sodium alkyl sulfate, sodium dodecyl sulfate, sodium dodecylbenzenesulfonate, sodium laurate, sodium laureth sulfate, sodium lauroyl sarcosinate, sodium myreth sulfate, sodium nonanoyloxybenzenesulfonate, sodium pareth sulfate, sodium stearate, and sulfolipid.

The cationic surfactant comprises at least one of behentrimonium chloride, benzalkonium chloride, benzethonium chloride, bronidox, cetrimonium bromide, cetrimonium chloride, dimethyldioctadecylammonium bromide, dimethyldioctadecylammonium chloride, lauryl methyl gluceth-10 hydroxypropyl dimonium chloride, octenidine dihydrochloride, olaflur, N-Oleyl-1,3-propanediamine, stearalkonium chloride, tetramethylammonium hydroxide, and thonzonium bromide.

The emulsion based foam further comprises a secondary fluid, wherein the secondary fluid comprises at least one of aromatics, alkanes, and crude oil, wherein the secondary fluid comprises 10% or less by volume of the emulsion based foam. The aromatics comprise at least one of benzene, naphtha, xylene, toluene, fuel oils, olefins, and diesel. The alkanes comprise at least one of heptane, octane, and hexane. The crude oil comprises at least one of NGL's, condensate, light oil, and medium oil.

In one embodiment, the fracturing fluid further comprises water, wherein the chemical agent comprises an emulsifying agent, and wherein the unfractionated hydrocarbon mixture, the water, and the emulsifying agent are combined to form an emulsion. The water is brine, seawater, and/or formation water and comprises up to 25% of the liquid phase of the emulsion based foam. The water is fresh water inhibited with potassium chloride and comprises up to 25% of the liquid phase of the emulsion based foam. The fresh water inhibited with potassium chloride comprises up to 4% potassium chloride. The emulsifying agent comprises a surfactant. The surfactant comprises a mass concentration of up to 5% of the emulsion. The surfactant is at least one of a nonionic surfactant, an anionic surfactant, and a cationic surfactant. The nonionic surfactant comprises at least one of a siloxane surfactant, a fluorosurfactant, a fatty acid ester, a glyceride, a silicon emulsifier, and a hydrophobic silica powder.

The anionic surfactant comprises at least one of 2-Acrylamido-2-methylpropane sulfonic acid, ammonium lauryl sulfate, ammonium perfluorononanoate, docusate, magnesium laureth sulfate, MBAS assay, perfluorobutanesulfonic acid, perfluorononanoic acid, perfluorooctanesulfonic acid, perfluorooctanoic acid, phospholipid, potassium lauryl sulfate, soap, soap substitute, sodium alkyl sulfate, sodium dodecyl sulfate, sodium dodecylbenzenesulfonate, sodium laurate, sodium laureth sulfate, sodium lauroyl sarcosinate, sodium myreth sulfate, sodium nonanoyloxybenzenesulfonate, sodium pareth sulfate, sodium stearate, and sulfolipid.

The cationic surfactant comprises at least one of behentrimonium chloride, benzalkonium chloride, benzethonium chloride, bronidox, cetrimonium bromide, cetrimonium chloride, dimethyldioctadecylammonium bromide, dimethyldioctadecylammonium chloride, lauryl methyl gluceth-10 hydroxypropyl dimonium chloride, octenidine dihydrochloride, olaflur, N-Oleyl-1,3-propanediamine, stearalkonium chloride, tetramethylammonium hydroxide, and thonzonium bromide.

The emulsion further comprises a secondary fluid, wherein the secondary fluid comprises at least one of aromatics, alkanes, and crude oil, and wherein the secondary fluid comprises 10% or less by volume of the emulsion. The aromatics comprise at least one of benzene, naphtha, xylene, toluene, fuel oils, olefins, and diesel. The alkanes comprise at least one of heptane, octane, and hexane. The crude oil comprises at least one of NGL's, condensate, light oil, and medium oil.

The chemical agent further comprises a viscosifier, wherein the viscosifier comprises at least one of a hydrocarbon soluble co-polymer and a water soluble viscosifier. The water soluble viscosifier comprises at least one of water soluble co-polymers, polysaccharides, guar gum, viscoelastic surfactants, crosslinkers, cellulosic viscosifiers, and hydroxyethyl cellulose. The chemical agent further comprises nanoparticles. The emulsion further comprises at least one of a mechanical diverting agent and a chemical diverting agent.

In one embodiment, the chemical agent comprises a gelling agent, wherein the unfractionated hydrocarbon mixture and the gelling agent are combined to form a gelled fracturing fluid. The gelling agent comprises at least one of hydrocarbon soluble copolymers, phosphate esters, organo-metallic complex cross-linkers, amine carbamates, alumunin soaps, cocoamine (C12-C14), sebacoyl chloride, oley (C18) amine, toulen-2,4-diisocyanate, tolune-2,6-diisolcyanate. The chemical agent further comprises nanoparticles. The gelled fracturing fluid further comprises at least one of a mechanical diverting agent and a chemical diverting agent

The gelled fracturing fluid comprises a secondary fluid, wherein the secondary fluid comprises at least one of aromatics, alkanes, and crude oil, and wherein the secondary fluid comprises 10% or less by volume of the gelled fracturing fluid. The aromatics comprise at least one of benzene, naphtha, xylene, toluene, fuel oils, olefins, and diesel. The alkanes comprise at least one of heptane, octane, and hexane. The crude oil comprises at least one of NGL's, condensate, light oil, and medium oil.

A method of fracturing a subsurface formation, such as a hydrocarbon bearing reservoir, comprises mixing a proppant, Y-Grade NGL, and at least one of a foaming agent, an emulsifying agent, and a gelling agent and to form a fracturing fluid; increasing the pressure of the fracturing fluid using one or more high pressure pumps; and injecting the fracturing fluid into the subsurface formation at a temperature at or below about 0 degrees Fahrenheit to fracture the subsurface formation.

A method of fracturing a hydrocarbon bearing reservoir comprises mixing Y-Grade NGL, a foaming agent, optionally a foam stabilizer, a proppant, and a gas, such as nitrogen, to form a hydrocarbon foam; and pumping the hydrocarbon foam into a hydrocarbon bearing reservoir via a wellhead to fracture the hydrocarbon bearing reservoir.

A method of fracturing a hydrocarbon bearing reservoir comprises mixing Y-Grade NGL, a surfactant, water, a proppant, and a gas, such as nitrogen, to form an emulsion based foam; and pumping the emulsion based foam into a hydrocarbon bearing reservoir via a wellhead to fracture the hydrocarbon bearing reservoir.

A method of fracturing a hydrocarbon bearing reservoir comprises mixing Y-Grade NGL, an emulsifying agent, water, and a proppant to form an emulsion; and pumping the emulsion into a hydrocarbon bearing reservoir via a wellhead to fracture the hydrocarbon bearing reservoir.

A method of fracturing a hydrocarbon bearing reservoir comprises mixing Y-Grade NGL, a gelling agent, and a proppant to form a gelled fracturing fluid; and pumping the gelled fracturing fluid into a hydrocarbon bearing reservoir via a wellhead to fracture the hydrocarbon bearing reservoir.

Advantages of using the Y-Grade NGL fracturing fluids as described herein for fracturing a subsurface formation, such as a hydrocarbon bearing reservoir, is the elimination of the large quantities of water needed for traditional water-based fracturing operations. An additional advantage includes the prevention or elimination of scaling within the wellbore and reservoir caused by water-based fracturing fluids. An additional advantage includes maintaining the relative permeability of the reservoir that is usually damaged by water-based fracturing fluids. Additional advantages include enhanced imbibition, miscibility, adsorption, and flowback of the Y-Grade NGL fracturing fluids with the reservoir and reservoir fluids compared to water-based fracturing fluids.

While the foregoing is directed to certain embodiments, other and further embodiments may be devised without departing from the basic scope thereof, and the scope thereof is determined by the claims that follow.

1. A Y-Grade NGL fracturing fluid, comprising:
a proppant;
an unfractionated hydrocarbon mixture comprising ethane, propane, butane, isobutane, and pentane plus, wherein the unfractionated hydrocarbon mixture is a byproduct of a condensed and de-methanized hydrocarbon stream, wherein the unfractionated hydrocarbon mixture is condensed out of the hydrocarbon stream at a temperature at or below 0 degrees Fahrenheit, wherein the unfractionated hydrocarbon mixture comprises ethane, propane, and butane in an amount of at least 75% by volume, and wherein the unfractionated hydrocarbon mixture comprises pentane plus in an amount less than 30% by volume; and
a chemical agent.

2. The fluid of claim 1, further comprising a gas, wherein the chemical agent comprises a foaming agent, and wherein the gas, the foaming agent, and the unfractionated hydrocarbon mixture are combined to form a hydrocarbon foam.

3. The fluid of claim 2, wherein the gas comprises at least one of carbon dioxide, nitrogen, natural gas, methane, LNG, and ethane.

4. The fluid of claim 2, wherein the foaming agent comprises a nonionic surfactant, wherein the nonionic surfactant comprises at least one of a siloxane surfactant, a fluorosurfactant, a fatty acid ester, a glyceride, a silicon emulsifier, and a hydrophobic silica powder, and wherein the nonionic surfactant comprises a mass concentration of up to 5%.

5. The fluid of claim 2, wherein the chemical agent further comprises a foam stabilizer, wherein the foam stabilizer is a hydrocarbon soluble copolymer.

6. The fluid of claim 2, further comprising a secondary fluid, wherein the secondary fluid comprises at least one of aromatics, alkanes, and crude oil, and wherein the secondary fluid comprises 10% or less by volume of the fracturing fluid.

7. The fluid of claim 6, wherein the crude oil comprises at least one of NGL's, condensate, light oil, and medium oil.

8. The fluid of claim 2, wherein the chemical agent further comprises nanoparticles.

9. The fluid of claim 2, further comprising at least one of a mechanical diverting agent and a chemical diverting agent.

10. The fluid of claim 1, further comprising water and a gas, wherein the chemical agent comprises a surfactant, and wherein the unfractionated hydrocarbon mixture, the water, the gas, and the surfactant are combined to form an emulsion based foam.

11. The fluid of claim 10, wherein the surfactant acts as a foaming agent, an emulsifying agent, or both.

12. The fluid of claim 10, wherein the water is at least one of brine, seawater, and formation water and comprises up to 25% of the liquid phase of the emulsion based foam.

13. The fluid of claim 10, wherein the water is fresh water inhibited with potassium chloride and comprises up to 25% of the liquid phase of the emulsion based foam, wherein the fresh water inhibited with potassium chloride comprises up to 4% potassium chloride.

14. The fluid of claim 10, wherein the gas comprises at least one of nitrogen, carbon dioxide, natural gas, methane, LNG, and ethane.

15. The fluid of claim 10, wherein the surfactant comprises at least one of a nonionic surfactant, an anionic surfactant, and a cationic surfactant, and wherein the surfactant comprises a mass concentration of up to 5%.

16. The fluid of claim 15, wherein the nonionic surfactant comprises at least one of a siloxane surfactant, a fluorosurfactant, a fatty acid ester, a glyceride, a silicon emulsifier, and a hydrophobic silica powder.

17. The fluid of claim 10, wherein the chemical agent further comprises a foam stabilizer, wherein the foam stabilizer is a hydrocarbon or water soluble copolymer.

18. The fluid of claim 10, further comprising a secondary fluid, wherein the secondary fluid comprises at least one of aromatics, alkanes, and crude oil, wherein the secondary fluid comprises 10% or less by volume of the emulsion based foam.

19. The fluid of claim 18, wherein the crude oil comprises at least one of NGL's, condensate, light oil, and medium oil.

20. The fluid of claim 10, wherein the chemical agent further comprises nanoparticles.

21. The fluid of claim 10, further comprising at least one of a mechanical diverting agent and a chemical diverting agent.

22. The fluid of claim 1, further comprising water, wherein the chemical agent comprises an emulsifying agent, and wherein the unfractionated hydrocarbon mixture, the water, and the emulsifying agent are combined to form an emulsion.

23. The fluid of claim 22, wherein the water is at least one of brine, seawater, and formation water and comprises up to 25% of the liquid phase of the emulsion.

24. The fluid of claim 23, wherein the water is fresh water inhibited with potassium chloride and comprises up to 25% of the liquid phase of the emulsion, wherein the potassium chloride water comprises up to 4% potassium chloride.

25. The fluid of claim 22, wherein the emulsifying agent comprises a surfactant, and wherein the surfactant is at least one of a nonionic surfactant, an anionic surfactant, and a cationic surfactant, and wherein the surfactant comprises a mass concentration of up to 5%.

26. The fluid of claim 25, wherein the nonionic surfactant comprises at least one of a siloxane surfactant, a fluorosurfactant, a fatty acid ester, a glyceride, a silicon emulsifier, and a hydrophobic silica powder.

27. The fluid of claim 22, further comprising a secondary fluid, wherein the secondary fluid comprises at least one of aromatics, alkanes, and crude oil, and wherein the secondary fluid comprises 10% or less by volume of the emulsion.

28. The fluid of claim 27, wherein the crude oil comprises at least one of NGL's, condensate, light oil, and medium oil.

29. The fluid of claim 22, wherein the chemical agent further comprises a viscosifier, wherein the viscosifier comprises at least one of a hydrocarbon soluble co-polymer and a water soluble viscosifier.

30. The fluid of claim 29, wherein the water soluble viscosifier comprises at least one of water soluble co-polymers, polysaccharides, guar gum, viscoelastic surfactants, crosslinkers, cellulosic viscosifiers, and hydroxyethyl cellulose.

31. The fluid of claim 22, wherein the chemical agent further comprises nanoparticles.

32. The fluid of claim 22, further comprising at least one of a mechanical diverting agent and a chemical diverting agent.

33. The fluid of claim 1, wherein the chemical agent comprises a gelling agent, wherein the unfractionated hydrocarbon mixture and the gelling agent are combined to form a gelled fracturing fluid.

34. The fluid of claim 33, wherein the gelling agent comprises at least one of hydrocarbon soluble copolymers, phosphate esters, organo-metallic complex cross-linkers, amine carbamates, alumunin soaps, cocoamine (C12-C14), sebacoyl chloride, oley (C18) amine, toulen-2,4-diisocyanate, tolune-2,6-diisolcyanate.

35. The fluid of claim 33, further comprising a secondary fluid, wherein the secondary fluid comprises at least one of aromatics, alkanes, and crude oil, and wherein the secondary fluid comprises 10% or less by volume of the gelled fracturing fluid.

36. The fluid of claim 35, wherein the crude oil comprises at least one of NGL's, condensate, light oil, and medium oil.

37. The fluid of claim 33, wherein the chemical agent further comprises nanoparticles.

38. The fluid of claim 33, further comprising at least one of a mechanical diverting agent and a chemical diverting agent.

39.-55. (canceled)
